(19) United States
(12) Patent Application Publication
(10) Pub. No.: US 2012/0138404 A1
(43) Pub. Date: Jun. 7, 2012

(54) STEERING DEVICE FOR A MOTOR VEHICLE HAVING A STEERING WHEEL AND AN ELECTRICAL CONTACT UNIT

(76) Inventor: Delf Neumann, Berlin (DE)

(21) Appl. No.: 13/390,173

(22) PCT Filed: Aug. 12, 2010
(86) PCT No.: PCT/EP2010/061763

§ 371 Date: Feb. 13, 2012

(30) Foreign Application Priority Data
Aug. 14, 2009 (DE) 10 2009 037 672.0

(51) Int. Cl. B60R 16/027; B60R 16/00

(52) U.S. Cl. 191/22 R

(57) ABSTRACT

A steering device for a motor vehicle is provided. In one form, the steering device includes a steering wheel and an electrical contact unit serving for guiding wires for electrically connecting at least one electrical or electronic component arranged in or on the steering wheel to at least one electrical or electronic component of a motor vehicle not arranged in or on the steering wheel. At least one part of an electronic control unit generating a temperature is integrated in the electrical contact unit for controlling at least one electrical or electronic component of the steering wheel. The electrical contact unit includes a stator and a rotor, and the electronic control unit or at least one part thereof generating a temperature are integrated in the rotor of an electrical contact unit.

The invention relates to a steering device for a motor vehicle with a steering wheel and an electrical contact unit according to the preamble of claim 1.

It is increasingly common to integrate a number of electrical and electronic vehicle components and functional elements in the steering wheel of a vehicle. It is for instance known from WO 2007/009420 A1 to integrate a superimposed drive for a superimposed steering system with an electric motor in a steering wheel. Superimposed steering systems are characterized in that a steering angle entered by the driver can be superimposed by a further angle by an actuator. Furthermore, the integration of electric operating elements in the steering wheel is known.

EP 1 040 982 A2 describes a steering wheel, wherein a heater integrated in the steering wheel rim of the steering wheel is controlled by the means of a steering wheel lever, which is arranged stationary on a mantle tube of a motor vehicle. The steering wheel lever comprises thereby a transfer module with an integrated power control unit for the heater.

The increasing integration of electrical and electronic vehicle components and operating elements provides an undesired heat development, which can endanger in the worst case the function of the respective component. Therefore, a desire exists to efficiently reduce heat, which is generated in or on the steering wheel.

The object of the present invention is thus to provide a steering device for a motor vehicle which avoids a high heat development in or on the steering wheel.

This object is solved according to the invention by a steering device with the features of claim 1. Embodiments of the invention are provided in the subclaims.

Accordingly, the present invention provides for transferring at least one temperature generating part of an electronic control unit (ECU=Electronic Control Unit), which serves the control of one or multiple of the electrical and electronic components of a steering wheel, out of the steering wheel into an electric contact unit of the steering device. Thereby, it is provided that the electric contact unit comprises a stator and a rotor and the electronic control unit or at least a temperature generating part thereof are integrated in the rotor of the electrical contact unit. The integration of the temperature generating part in the rotor means thereby that the temperature generating part is connected either directly or indirectly via a carrier torque-proof to the rotor.

Thus, at least one temperature generating electronic component for signal processing and/or signal transfer of the electronic control unit or the electronic control unit in its entirety is transferred into the rotor of an electrical contact unit.

By transferring the electronic control unit or the temperature generating parts thereof out of the steering wheel and into the rotor of the electrical contact unit the development of heat in the steering wheel is reduced since the heat generated by the control unit or temperature generating parts thereof is now present in the electrical contact unit and accordingly the electrical contact unit is heated. It is in particular avoided that the steering wheel skeleton is heated by the electronic control unit or the temperature generating parts thereof. Thereby, it is improvingly possible to dissipate the heat generated by other electrical or electronic components in the steering wheel effectively out of the steering wheel, as for instance the heat provided by a driving motor of a superimposed drive or electrical operating elements.

By integrating parts of the electronic control unit in the rotor of the electrical contact unit it is furthermore achieved that these parts are arranged close to the components of the steering wheel and the electrical contacts and conductors between the parts of the electronic control unit and the components of the steering wheel, with which these are electrically connected, do not undergo a relative movement in respect to the steering wheel due to the integration in the rotor. Thereby, the danger of disturbances during signal transfer is reduced and simple possibilities of the electrical contacting, for instance via a plug, are provided.

A further advantage of integrating parts of the electronic control unit in the rotor (opposite to a vehicle fixed area) is that the number of connecting conductors between the electronic control unit and a complex actuation system (as for instance for superimposed steering system) do not have to be guided via a flexible conductor.

In an embodiment of the invention the rotor comprises a circular carrier, wherein the electronic control unit or at least a temperature generating part thereof is arranged on said carrier. The circular carrier is for instance formed disc-like. The rotor is rotated when rotating the steering wheel.

Thereby it can be provided that the electrical contact unit comprises means for heat dissipation. A heat dissipation occurs for instance through a housing of the electrical contact unit. This serves beside the protection and the guidance of a flexible conductor also as heat dissipater and can comprise cooling ribs and/or active cooling elements. Thereby, large surfaces on the housing of the electrical contact unit or temperature dissipating surfaces for temperature dissipation can also be provided in a simple manner. Furthermore, means for temperature uptake and dissipation, for instance in form of cooling ribs or cooling slots, can be provided on the rotor of the electrical contact unit, in which in an embodiment of the invention the electronic control unit or temperature generating parts thereof are integrated. It can also be provided that the electrical contact unit comprises a lid element, wherein the steering shaft or a steering shaft stump of the steering shaft or a coupling element coupled with the steering shaft projects through said lid element, wherein the lid element comprises means for dissipating heat, which is provided by the electronic control unit or at least one temperature generating part thereof.

The singular elements are thereby arranged in an embodiment and optimized in their function and synchronized such that when rotating the steering wheel and the rotor connected torque-proof thereto an additional ventilation of the electrical contact unit occurs and thus the heat generation is further reduced.

An electrical contact unit is a component, which serves the electrical connection of one or multiple electrical or electronic components arranged in a steering wheel to one or multiple electrical or electronic components not arranged in the steering wheel. A component not arranged in the steering wheel can thereby be also a power source for a component arranged in the steering wheel. An electrical contact unit comprises a flexible conductor for instance in form of a clock spring, which electrically couples a stator of the contact unit to a rotor of the contact unit, wherein signals as well as energy can be transferred by the electrical coupling. Signals and/or energy can also be transferred by the means of the flexible conductor during a relative movement between rotor and stator.

The rotor and the flexible conductor are thereby arranged in an embodiment axially one after the other in respect to the rotational axis of the steering shaft of the steering wheel. In an alternative embodiment the rotor and the flexible conductor are arranged in radial direction successively in respect to the rotational axis of the steering shaft and the steering wheel, wherein the flexible conductor is radial outwards enclosed by the rotor.

In a further embodiment a superimposed drive is integrated in the steering wheel and the control unit is formed to control at least the superimposed drive.

The invention is subsequently explained in more detail with reference to the Figures of the drawings by the means of multiple embodiments.

It shows:

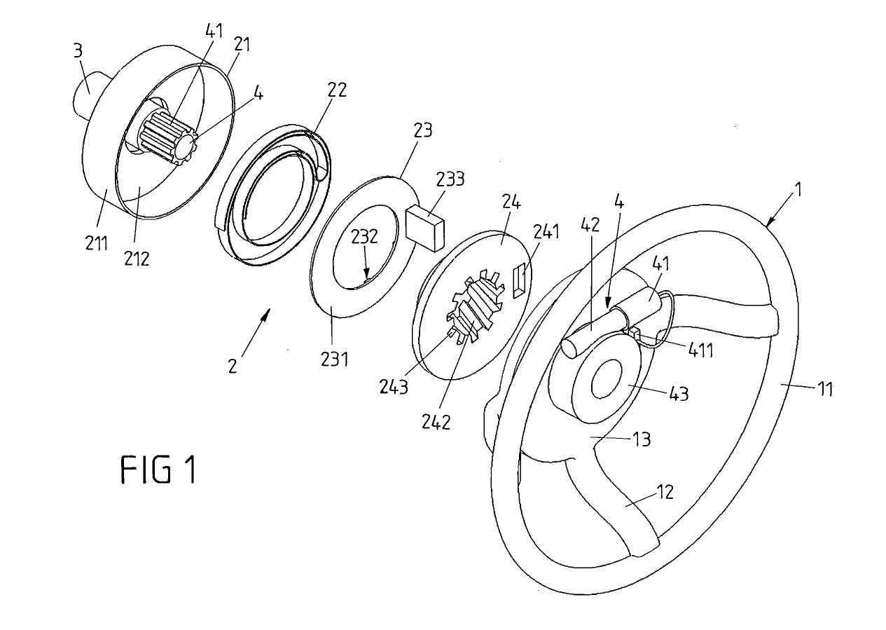

FIG. 1 an explosive illustration of a first embodiment of a steering wheel with an electrical contact unit, in which an electronical control unit is integrated;

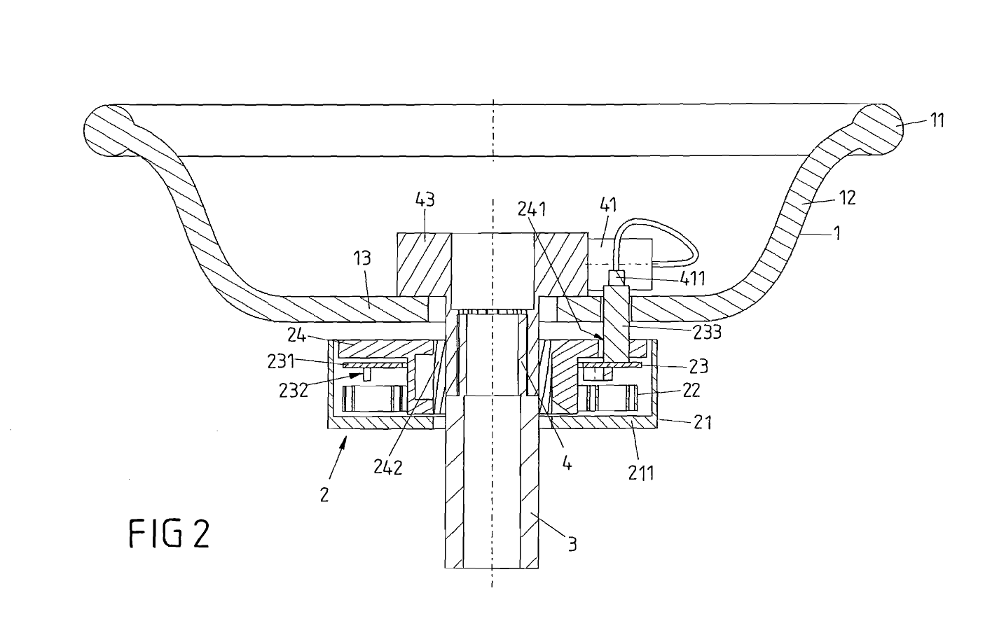

FIG. 2 a sectional illustration of the assembled steering wheel of FIG. 1;

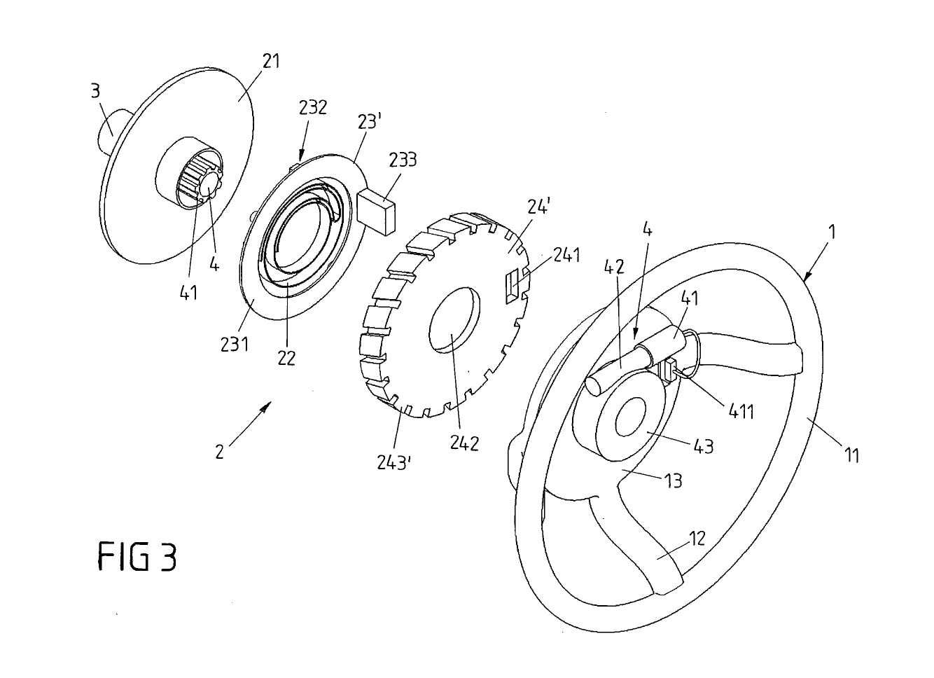

FIG. 3 an explosive illustration of a second embodiment of a steering wheel with an electrical contact unit, in which an electronic control unit is integrated;

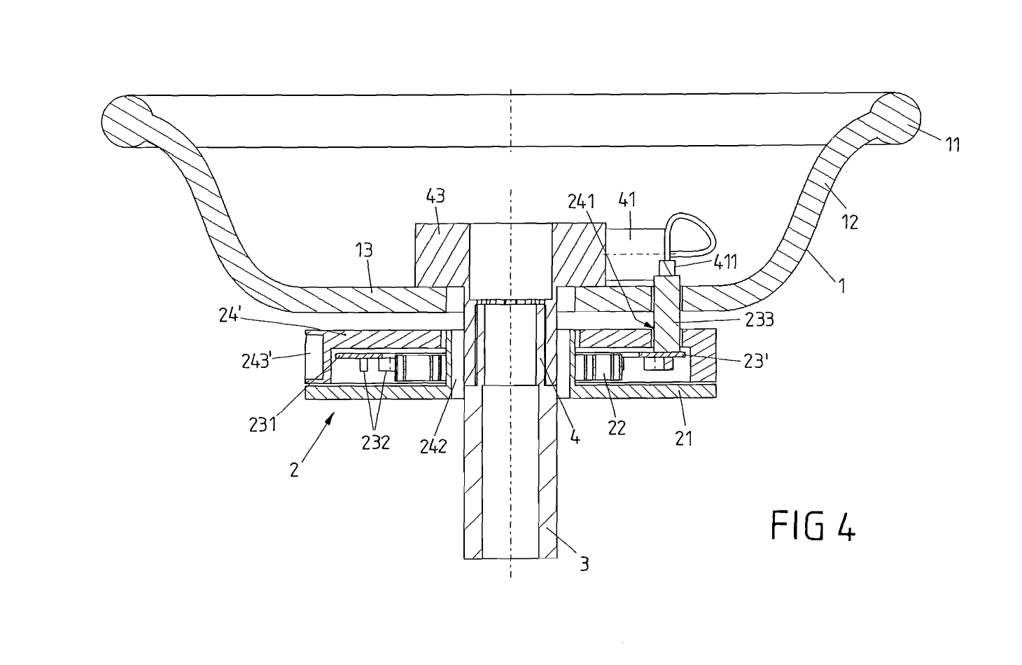

FIG. 4 a sectional illustration of the assembled steering wheel of FIG. 3.

The steering device illustrated in FIGS. 1 and 2 comprises a steering wheel 1 and an electrical contact unit 2.

The steering wheel 1 comprises a steering wheel rim 11, multiple spokes 12 and a steering wheel hub 13, which serves when connecting the steering wheel 1 to a steering shaft 3.

In the area of the steering wheel hub 13 a superimposed drive 4 is integrated in the steering wheel 1, which comprises an actuator in form of an electromotor 41 and a superimposed transmission with a driving worm 42 and a worm wheel 43. The driving worm 42 is driven by the electromotor 41. The worm wheel 43 is coupled to the steering shaft 3. The superimposed drive 4 is suitable and designed to superimpose a steering angle entered by a driver with a further steering angle.

In the illustration of FIG. 1 a housing as well as transmission elements and fixing means of the superimposed transmission 42, 43 and the driving motor 41 are not illustrated for a better overview.

The electrical contact unit 2 comprises a stator 21, a flexible conductor 22, a rotor 23 and an upper lid 24.

The stator 21 is stationary, that means is fixed not rotatably, for instance in a steering column housing or a steering lever component immediately arranged behind the steering wheel 1. Said stator is designed, but not necessarily, hollow cylindrical in the illustrated embodiment and comprises an outer wall 211 being circular in cross section and a lower lid 212 opposing the steering wheel 1. The lid 212 comprises a central recess, wherein a steering shaft stump 4 of the steering shaft 3 provided with a toothing 41 projects through said recess. Due to the cylindrical wall 211 a cylindrical hollow space is provided, which serves to receive the flexible conductor 22 as well as the rotor 23 and which can be closed by the upper lid 24 on the side of the electrical contact unit 2 facing the steering wheel.

The flexible conductor 22 is for instance formed as a clock spring. Said conductor is connected electrically or signal conducting to the stator 21 on an end or end area by the means of one or multiple contact points, which are not shown. On its other end or end area said conductor is connected electrically and signal conducting to the rotor 23 on one or multiple contact points (also not shown). The flexible conductor 22 allows for transferring energy and/or signals between the components electrically coupled to the stator and components electrically coupled to the rotor also during a relative movement of the components. Thereby, the flexible conductor 22 is also moved due to its flexibility during a relative movement between stator 21 and rotor 23. The exact design of the flexible conductor 22 is thereby not essential for the present invention. The illustrated flexible conductor 22 is only to be understood as an example.

The rotor 23, which is electrically and signal-conducting connected to the flexible conductor 22 by the means of one or multiple contact points not shown as already explained, comprises in the illustrated embodiment a ring and disk-like carrier 231. Electronic components for signal processing and/or signal transfer are arranged on said carrier, wherein said components illustrate an electronic control unit 232 (ECU). These electronic components comprise for instance one or multiple microprocessors and memory chips.

The electronic components are arranged in the illustrated embodiment exclusively on the side of the circular carrier 231 facing away from the steering wheel 1. Basically, the electronic components can also be arranged on the other side and/or on both sides of the carrier 231. The circular carrier 231 can thereby be provided with integrated electrical conductors according to a circuit board. The circular carrier 231 comprises furthermore an electrical connecting point 233, for instance in form of an electrical plug-in connection port or plug-in contact. The circular carrier 231, the electronic control unit 232 and the electrical connecting point 233 form thereby a sub-component, which is also designated as ECU unit.

It is pointed out that it can be provided that not all components of the electronic control unit 232 are arranged on the circular carrier 231, but only the heat generating components. Other optionally present components of the control unit can be arranged in contrast on the steering wheel 1.

A plug 411 of the driving motor 41 of the superimposed drive 4 is inserted into the electrical connecting point 233. The contact unit 2 serves insofar the electrical supply of the illustrated motor 41 of the superimposed steering system. The contact unit 2 can serve furthermore also the power supply and/or signal technical connection of further electrical consumers arranged in the steering wheel 1, such as electrical operating elements in the steering wheel as well as electrical components of an airbag module. The electrical connecting point 233 is accordingly designed to provide an electrical connection also to such further electrical consumers, why for instance plug receivers for plugs of further electrical consumers are provided.

The control unit 232 serves the electrical control of one or multiple electrical components arranged in the steering wheel 1, for instance the electrical control of the superimposed steering system as well as the electrical control of electrical operating elements of the steering wheel. The control unit 232 can be thereby basically also having control functions in respect to vehicle components, which are not arranged in the steering wheel. The control unit 232 can be designed and provided for instance to control a servo steering, which is coupled outside of the steering wheel 1 to the steering shaft 3.

The upper lid 24 closes the electrical contact unit 2. Said lid comprises an opening 241 on the rim side thereof, which serves the passing of the electrical connecting point 233, which projects in direction of the steering wheel 1 and into the same and is connected in the illustrated embodiment to the plug 411 of the drive motor 41. The lid 24 comprises furthermore a central opening 242, which is provided with cooling ribs 242 in form of lamellae or slots. In an embodiment these ribs do not continue parallel to the rotational axis of the steering shaft 3, but are tilted towards said axis in order to provide an improved cooling effect.

It is pointed out that the diameter of the central opening 242, as in particular deducible by the means of the sectional illustration of FIG. 2, is larger than the diameter of the steering shaft 3 or a part of the worm wheel 43 coupling with the steering shaft stump 4. This allows for an effective dissipation of heat by the cooling ribs 43.

FIGS. 3 and 4 show an embodiment, which differs from the embodiment of FIGS. 1 and 2 in particular in the arrangement of the flexible conductor 22 and the rotor 23. While in case of the embodiment of the FIGS. 1 and 2 the rotor 23 and the flexible conductor 22 are arranged one after the other in direction of the rotational axis of the steering shaft 3, the rotor 23′ and the flexible conductor 22 are arranged radial successively in respect to the rotational axis of the steering shaft 3 in the embodiment of FIGS. 3 and 4. The flexible conductor 22 is thereby enclosed radial outwards by the rotor 23′. In the first case (FIGS. 1 and 2) the ECU unit is thus placed as a ring around the steering shaft 3 and directly on the conducting band of the flexible conductor 22 and is for instance fixed tightly to said conductor. In the second case (FIGS. 3 and 4) the ECU unit is placed as a ring radial outwards around the conducting band of the flexible conductor 22 and is for instance connected tightly to said conductor.

These differences in the arrangement cause different expansions or dimensions of the contact unit 2 in the two selected directions and allow thus an adaptation to the respective construction space.

In the embodiments of FIGS. 3 and 4 it is furthermore provided that cooling means in form of cooling ribs 243′ are provided at the rim of the lid 24′. Such cooling ribs can also be formed in addition at the central opening 242. A further difference is that the stator 21 is provided as a disc and does not form a housing.

It is also possible to combine the embodiments illustrated on the one hand in FIGS. 1, 2 and on the other hand in FIGS. 3, 4.

The invention is not restricted in its embodiment to the illustrated embodiments. The steering device according to the invention can also be formed without a superimposed steering system. An electromotor thereof is solely an example for an electrical component integrated in a steering wheel, the operation thereof controlled by a control unit. It can be furthermore provided in other embodiments that the control unit is integrated in the stator instead of the rotor.

1. A steering device for a motor vehicle comprising a steering wheel and an electrical contact unit, which serves the guidance of wires for electrically connecting at least one electrical or electronic component arranged in or on the steering wheel to at least one electrical or electronic component of a motor vehicle not arranged in or on the steering wheel,
wherein at least one temperature generating part of an electronic control unit for controlling at least one electrical or electronic component of the steering wheel is integrated into the electrical contact unit,
wherein the electrical contact unit comprises a stator and a rotor and that the electronic control unit or at least one temperature generating part thereof is integrated in the rotor of the electrical contact unit, and
wherein a superimposing drive is integrated in the steering wheel and the control unit is designed to control at least the superimposing drive.

2. The steering st device according to claim 1, wherein the rotor comprises a circular carrier, wherein the electronic control unit or at least a temperature generating part thereof is arranged on said carrier.

3. The steering device according to claim 2, wherein the circular carrier is formed disc-like.

4. The steering device according to claim 1, further comprising a flexible conductor of the electrical contact unit, which is electrically connected on the one hand to the stator of the contact unit and on the other hand to the rotor of the contact unit.

5. The steering device according to claim 4, wherein the rotor and the flexible conductor are arranged axially one after the other in respect to the rotational axis of the steering shaft of a steering wheel.

6. The steering device according to claim 4, wherein the rotor and the flexible conductor are arranged in radial direction successively in respect to the rotational axis of the steering shaft of the steering wheel, wherein the flexible conductor is surrounded radial outside by the rotor.

7. The steering device according to claim 1, wherein the rotor comprises an electrical connecting point, which is designed to be connected to one or multiple electrical cables of electrical or electronic components of the steering wheel, wherein signals as well as energy can be transferred via the electrical connecting point.

8. The steering device according to claim 1, wherein the electrical contact unit comprises means for dissipating heat, which is provided by the electronic control unit or at least one temperature generating part thereof.

9. The steering device according to claim 1, wherein the electrical contact unit comprises a lid element, wherein the steering shaft or a steering shaft stump of the steering shaft or a coupling element coupled to the steering shaft projects through said lid element, wherein the lid element provides means, for dissipating heat, which is provided by the electronic control unit or at least one temperature generating part thereof.

10. The steering device according to claim 9, wherein the means comprise an internal opening and internal cooling ribs arranged therein.

11. The steering device according to claim 9, wherein the means comprise external cooling ribs on the circumference of the lid element.

12. The steering device according to claim 9, wherein the cooling ribs are formed inclined to the rotational axis of the steering shaft.

13. The steering device according to claim 1, wherein the control unit is integrated completely in the electrical contact unit.

14. The steering device according to claim 1, wherein electronic components for signal processing and/or signal transfer are arranged on the carrier, wherein said components form the electronic control unit.

15. (canceled)
